(19) United States
(12) Patent Application Publication
(10) Pub. No.: US 2013/0129263 A1
(43) Pub. Date: May 23, 2013

(54) LINEAR SLIDING BLOCK

(71) Applicant: Kuo-Le Tsao, New Taipei City (TW)

(72) Inventor: Kuo-Le Tsao, New Taipei City (TW)

(21) Appl. No.: 13/434,849

(22) Filed: Mar. 29, 2012

(30) Foreign Application Priority Data
Nov. 17, 2011 (TW) 100221691

(51) Int. Cl. F16C 33/10

(52) U.S. Cl. 384/13

(57) ABSTRACT

A linear sliding block includes a base block, two circulation-guiding blocks coupled to two ends of the base block and a plurality of rolling balls accommodated in the base block. The base block includes a body member and a cover member. The bottom of the base block has a sliding groove. The cover member is integrally formed with the body member to cover a part of the body member. The cover member includes two end block portions, at least one connection portion connected between the two end block portions and two load-bearing tracks formed at two sides of the sliding groove. Each end block portion of the cover member is formed with a first oil passage facing the relative circulation-guiding block. Each load-bearing track is formed with a second oil passage. Two ends of the second oil passage communicate with the first oil passage.

### CROSS REFERENCE TO RELATED APPLICATIONS

This application is based upon and claims the benefit of priority from the prior Taiwan Patent Application No. 100221691, filed on Nov. 17, 2011, the entire contents of which are incorporated herein by reference.

### BACKGROUND OF THE INVENTION

(a) Field of the Invention

The present invention relates to a linear sliding block, and more particularly to a linear sliding block to carry an object for enabling the object to move along a linear sliding rail.

(b) Description of the Prior Art

A linear sliding rail and a linear sliding block are precise mechanical parts, which are applied to tool machines, special machines, automatic control machines, and so on. They are one of common rectilinear motion devices. A conventional linear sliding block comprises a base block, two circulation-guiding blocks, and a plurality of rolling balls. The bottom of the base block has a sliding groove to fit on the linear sliding rail and a pair of load-bearing tracks symmetrically disposed at two opposite lateral sides of the sliding groove. The base block has non-load tracks extending through opposing front and rear ends thereof. The circulation-guiding blocks are respectively coupled to the opposing front and rear ends of the base block, such that the load-bearing tracks communicate with the non-load tracks through the circulation-guiding blocks. The rolling balls are received in the load-bearing tracks and the non-load tracks. When the sliding groove of the linear sliding block is fitted on the linear sliding rail, the rolling balls in the load-bearing tracks load the linear sliding block to guide the linear sliding block to slide along the linear sliding rail smoothly and stably. To avoid friction of the rolling balls, oil grooves are formed in the circulation-guiding blocks to store lubricating oil. When the rolling balls move through the circulation-guiding blocks, the lubricating oil will lubricate the rolling balls. In this way, the rolling balls and the linear sliding rail won't suffer a lot of wear and tear.

The rolling balls can be lubricated only when they move through the oil grooves of the circulation-guiding blocks, i.e., the rolling balls are not sufficiently lubricated during rolling in the load-bearing tracks. When the rolling balls in the load-bearing tracks roll at a high speed, the lubricating oil may fling away and flow away to result in that the rolling balls are not lubricated enough. Besides, the base block must be drilled or cut for the load-bearing tracks and the non-load tracks. This causes complicated manufacture procedures and high cost. Furthermore, the linear sliding block and linear sliding rail are often used in mechanical structures. During the sliding motion of the linear sliding block on the linear sliding rail in the work place, surrounding dust, iron and other foreign objects may enter the gaps between the load-bearing tracks and the rolling balls to be accumulated thereat. The conventional design has no means to expel foreign objects, leading to wear and tear of the rolling balls and the load-bearing tracks, or vibration or jamming of the linear sliding block.

Accordingly, the inventor of the present invention has devoted himself based on his many years of practical experiences to solve these problems.

### SUMMARY OF THE INVENTION

The primary object of the present invention is to provide a linear sliding block which comprises a base block. The base block includes a body member and a cover member to cover a part of the body member. The cover member is integrally formed with the body member by plastic injection molding. During the procedure of forming, the cover member is formed with a first oil passage and a second oil passage to simplify manufacture procedures without drilling or cutting so as to save manpower and material. The cost can be lowered effectively.

A further object of the present invention is to provide a linear sliding block, wherein lubricating oil can fully lubricate the rolling balls in the load-bearing tracks through the first and second oil passages of the cover member of the base block.

Another further object of the present invention is to provide a linear sliding block, wherein the second oil passage of the cover member of the base can be a groove to expel bits and small pieces. When iron chip, dust or foreign objects enter the load-bearing tracks, they can be brought to the second oil passage by rolling of the rolling balls to keep the foreign objects off so as to prevent wear and tear.

### BRIEF DESCRIPTION OF THE DRAWINGS

FIG. 1 is an exploded view showing the linear sliding block and the linear sliding rail;

FIG. 2 is an exploded view showing the linear sliding block according to a preferred embodiment of the present invention;

FIG. 3 is a perspective view showing the base block according to the preferred embodiment of the present invention;

FIG. 4 is a side view showing the base block according to the preferred embodiment of the present invention;

FIG. 5 is a perspective view showing the body member according to the preferred embodiment of the present invention;

FIG. 6 is a partial sectional view showing the cover member and the base block according to the preferred embodiment of the present invention;

FIG. 7 is a sectional view showing the cover member and the base block according to the preferred embodiment of the present invention; and

FIG. 8 is a sectional view showing the linear sliding block of the present invention when in use.

### DETAILED DESCRIPTION OF THE PREFERRED EMBODIMENTS

Embodiments of the present invention will now be described, by way of example only, with reference to the accompanying drawings.

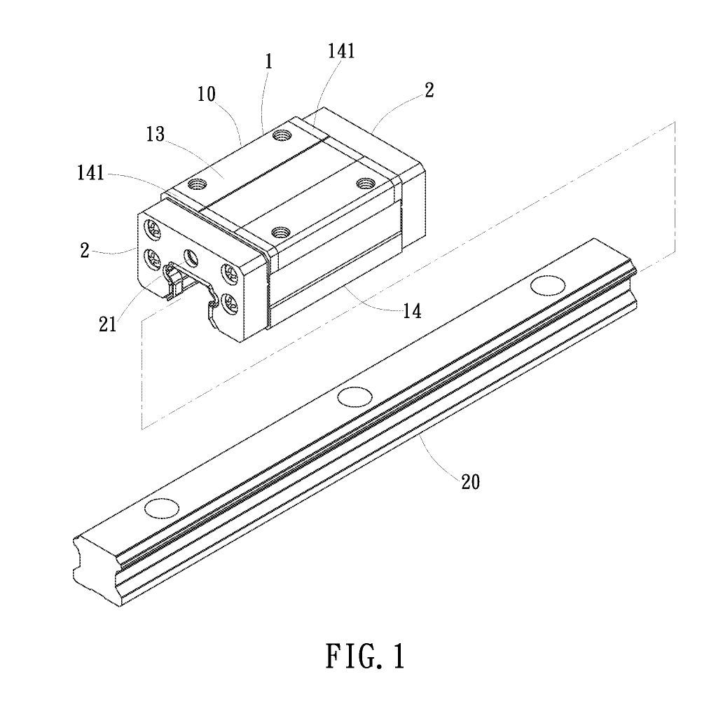

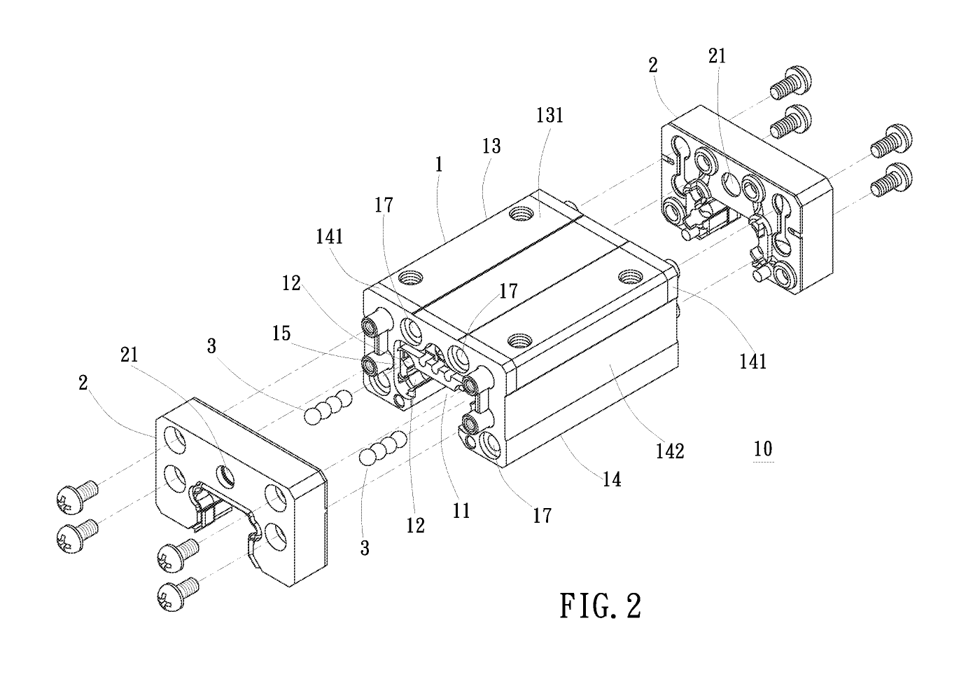

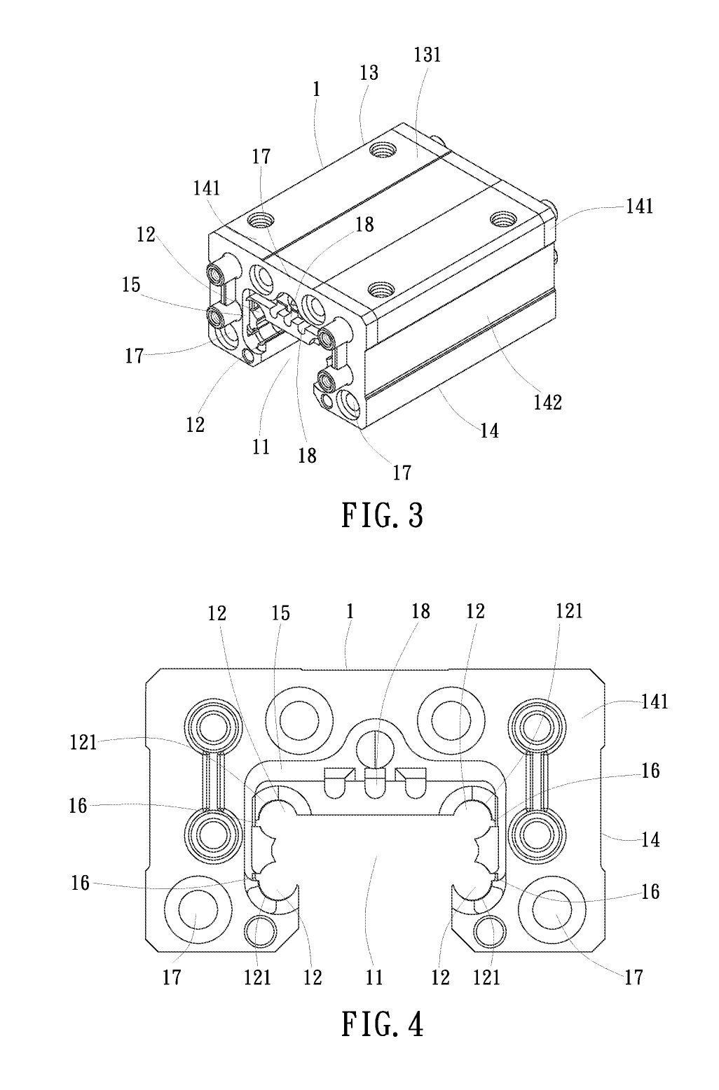

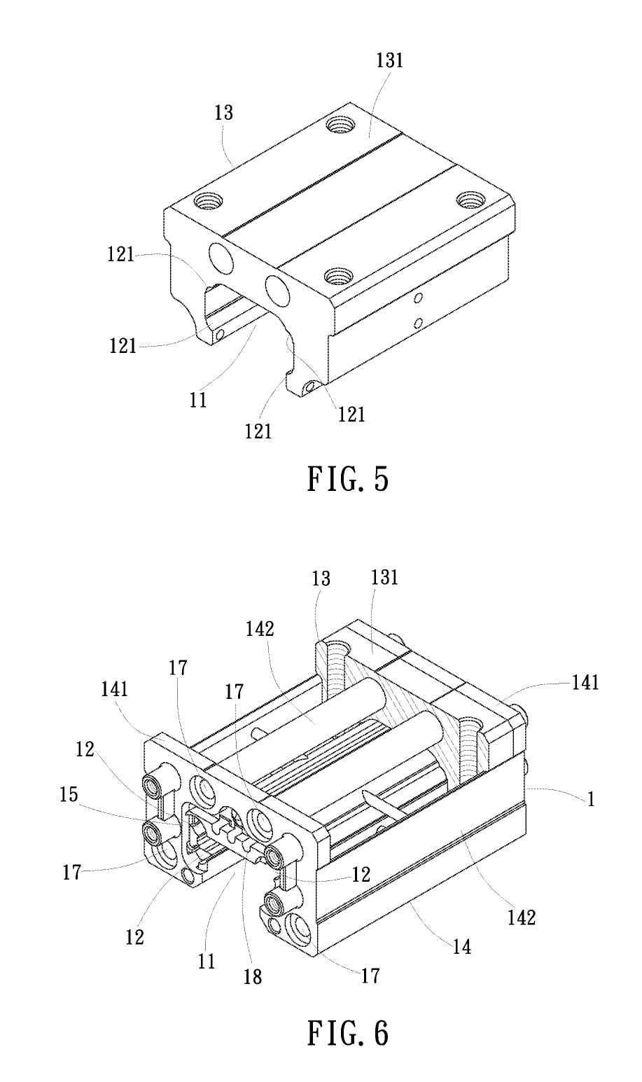

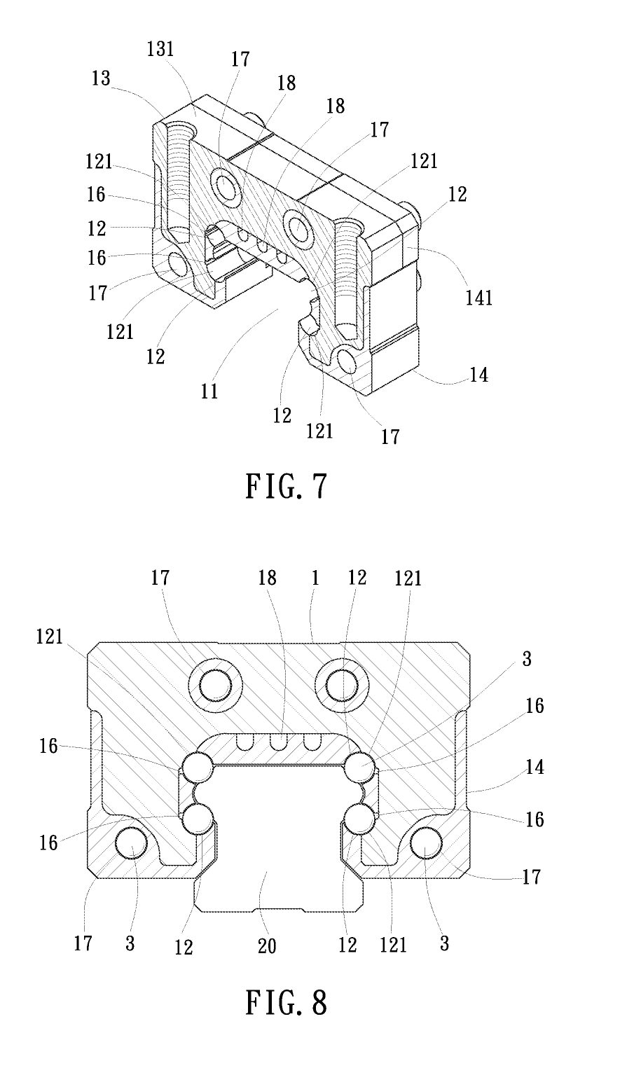

As shown in FIG. 1 and FIG. 2, a linear sliding block 10 mounted on a linear sliding rail 20 according to a preferred embodiment of the present invention comprises a base block 1, two circulation-guiding blocks 2, and a plurality of rolling balls 3. The base block 1 is a rectangular block. The base block 1 has a sliding groove 11 corresponding to the linear sliding rail 20 at a bottom thereof and at least a pair of load-bearing tracks 12 at two sides of the sliding groove 11. The two circulation-guiding blocks 2 are coupled to two ends of the base block 1 and respectively communicates with the load-bearing tracks 12. The plurality of rolling balls 3 are received in the load-bearing tracks 12 of the base block 1 to slide along the linear sliding rail 20, so that the linear sliding block 10 can slide smoothly. Referring to FIG. 3 and FIG. 4, the base block 1 comprises a body member 13, and a cover member 14 to cover a part of the body member 13. As shown in FIG. 5, the body member 13 is a block made of a metallic material, and comprises a top 111 exposed outside the cover member 14 and a bottom opposite to the top 111. The bottom is formed with the sliding groove 11. As shown in FIG. 3, FIG. 6 and FIG. 7, the cover member 14 is integrally formed with the body member 13 by plastic injection molding to cover a part of the body member 13. The cover member 14 comprises two end block portions 141 to cover two opposing ends of the body member 13 and at least one connection portion 142 connected between the two end block portions 14. By injection molding, the cover member 14 is coupled to the base block 1 and the load-bearing tracks 12 are formed at the two sides of the sliding groove 11.

As shown in FIG. 3 and FIG. 4, each of the two end block portions 141 of the cover member 14 is formed with a first oil passage 15 facing the relative circulation-guiding block 2. At least one side of the first oil passage 15 communicates with the load-bearing tracks 12. Each of the load-bearing tracks 12 is formed with a second oil passage 16 which extends along the relative load-bearing track 12 to the two end block portions 141 of the cover member 14. Two ends of the second oil passage 16 communicate with the first oil passage 15. Thus, the lubricating oil filled into the first oil passages 15 can flow into the second oil passages 16 of the load-bearing tracks 12 to lubricate the rolling balls 3 in the load-bearing tracks 12.

As shown in FIG. 3 and FIG. 4, the first oil passage 15 of the present invention has a reverse U shape and is a groove surrounding the sliding groove 11 and communicates with the load-bearing tracks 12 at the two sides of the sliding groove 11, so that the lubricating oil can lubricate the rolling balls 3 in the load-bearing tracks 12 at the two sides of the sliding groove 11.

The second oil passages 16 of the present invention are grooves disposed in the load-bearing tracks 12, so that the lubricating oil into the second oil passages 16 are contact with the rolling balls 3 to lubricate the rolling balls 3.

Referring to FIG. 7 and FIG. 8, the load-bearing tracks 12 formed by the cover member 14 communicate with the sliding groove 11 for the rolling balls 3 to slide therein. The rolling balls 3 in the load-bearing tracks 12 roll on the linear sliding rail 20. In order to enhance the bearing power and the precision of the load-bearing tracks 12, the two sides of the sliding groove 11 of the body member 13 have load portions 121 to load the plurality of the rolling balls 3. Each load portion 121 has a cambered surface. When the cover member 14 is formed by injection molding to have the load-bearing tracks 12, the load portions 121 are exposed in the load-bearing tracks 12, so that the rolling balls are contact with the load portions 121, achieving more preciseness and load.

Referring to FIG. 6 and FIG. 7, the cover member 14 is formed with a non-load track 17 which communicates with the two end block portions 141. When the two circulation-guiding blocks 2 are coupled to the two end block portions 141, two ends of the non-load track 17 communicate with the load-bearing tracks 12 through the inner configurations of the respective circulation-guiding blocks 2 to achieve the circulation rolling of the rolling balls 3. By the integral configuration of the cover member 14, there is no need to drill the metallic body member 13, so the manufacture procedure is simplified and the cost is lowered.

Referring to FIG. 3 and FIG. 4, each of the two end block portions 141 of the cover member 14 further has a third oil passage 18 to communicate with the first oil passage 15, so that the lubricating oil can flow to the two ends fully. The position for the lubricating oil filled into the first oil passage 15 can be disposed at either of the two end block portions 141 of the cover member 14, alternatively, at one of the circulation-guiding blocks 2 as shown in FIG. 2. The circulation-guiding block 2 has an oil hole 21 to communicate with the first oil passage 15 for filling lubricating oil into the first oil passage 15, the second oil passage 16 and the third oil passage 18.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A linear sliding block mounted on a linear sliding rail, comprising a base block, two circulation-guiding blocks coupled to two ends of the base block and a plurality of rolling balls disposed in the base block;
the base block comprising a body member and a cover member, the body member comprising an exposed top and a bottom opposite to the top, the bottom of the base block having a sliding groove and at least a pair of load-bearing tracks at two sides of the sliding groove, the cover member being integrally formed with the body member by plastic injection molding to cover a part of the body member, the cover member comprising two end block portions, at least one connection portion connected between the two end block portions and the load-bearing tracks which are formed at the two sides of the sliding groove, each of the two end block portions of the cover member being formed with at least one first oil passage facing the relative circulation-guiding block, one side of the first oil passage communicating with the load-bearing tracks, each of the load-bearing tracks being formed with a second oil passage, two ends of the second oil passage communicating with the first oil passage; and
the plurality of rolling balls being received in the load-bearing tracks of the base block to slide along the linear sliding rail.

2. The linear sliding block as claimed in claim 1, wherein the first oil passage is a groove surrounding the sliding groove and communicates with the load-bearing tracks at the two sides of the sliding groove.

3. The linear sliding block as claimed in claim 1, wherein the second oil passage is a groove disposed in the load-bearing tracks.

4. The linear sliding block as claimed in claim 1, wherein the load-bearing tracks formed by the cover member communicate with the sliding groove; the two sides of the sliding groove of the body member have load portions to load the plurality of the rolling balls, and the load portions are exposed in the load-bearing tracks.

5. The linear sliding block as claimed in claim 4, wherein the cover member is formed with a non-load track which communicates with the two end block portions, and two ends of the non-load track communicate with the load-bearing tracks through the respective circulation-guiding blocks.

6. The linear sliding block as claimed in claim 1, wherein each of the two end block portions of the cover member further has a third oil passage to communicate with the first oil passage.

7. The linear sliding block as claimed in claim 1, wherein each of the circulation-guiding blocks has an oil hole to communicate with the first oil passage.
